(19) United States
(12) Patent Application Publication
(10) Pub. No.: US 2008/0315778 A1
(43) Pub. Date: Dec. 25, 2008

(54) LIGHT-EMITTING-DIODE DRIVE CIRCUIT

(76) Inventor: Masaaki TATSUKAWA, Yamatokoriyama-shi (JP)

Correspondence Address: BIRCH STEWART KOLASCH & BIRCH, PO BOX 747, FALLS CHURCH, VA, 22040-0747, US

(21) Appl. No.: 12/134,929

(22) Filed: Jun. 6, 2008

(30) Foreign Application Priority Data
Jun. 20, 2007 (JP) 2007-162447

(51) Int. Cl. H05B 41/36; H05B 37/02

(52) U.S. Cl. 315/193; 315/294

(57) ABSTRACT

A light-emitting-diode drive circuit for driving n (where n is a natural number equal to or greater than two) light-emitting diodes (LED1 to LEDn) connected in series includes n′ (where n′ is any natural number equal to or greater than two but equal to or less than n; here, n′=n−1) lit-LED number control switches (SW1 to SWn−1). Here, there are n′ ways of turning on only one of the n′ lit-LED number control switches (SW1 to SWn−1) and there are, as corresponding to those n′ ways, n′ ways of lighting different numbers of light-emitting diodes among the n light-emitting diodes (LED1 to LEDn) connected in series.

This nonprovisional application claims priority under 35 U.S.C. §119 (a) on Patent Application No. 2007-162447 filed in Japan on Jun. 20, 2007, the entire contents of which are hereby incorporated by reference.

### BACKGROUND OF THE INVENTION

1Field of the Invention

The present invention relates to a light-emitting-diode drive circuit and more particularly to a light-emitting-diode drive circuit having light-control capability.

2. Description of Related Art

In a light-emitting-diode drive circuit to which a plurality of light-emitting diodes are connected, to keep constant the amount of light emitted by each of the light-emitting diodes when they are lit, it is necessary to keep constant the forward current through the light-emitting diodes when they are driven. One method to pass the same amount of forward current through the light-emitting diodes when they are driven is to connect the light-emitting diodes in series using a chopper regulator or the like as a drive circuit. This method is commonly used because it requires relatively low cost and permits easy mounting.

FIG. 10 is a diagram showing an example of the configuration of a conventional light-emitting-diode drive circuit. The conventional light-emitting-diode drive circuit shown in FIG. 10 serves as a chopper regulator; it is composed of an input capacitor 2, a coil 3, a diode 4 serving as a rectifier element, an output capacitor 5, an output current-setting resistor Rset and a step-up chopper regulator IC 100 integrated into one package that steps up voltage by switching between the storage and release of energy into and out of the coil 3. The conventional light-emitting-diode drive circuit shown in FIG. 10 steps up a direct-current voltage supplied from a direct-current power supply 1 such as a lithium-ion battery, and uses the stepped-up direct-current voltage to drive n (where n is any natural number equal to or greater than two) light-emitting diodes (load) LED1 to LEDn that serve as, for example, an illumination source in an LCD incorporated in an electronic device such as a mobile telephone.

The negative terminal of the direct-current power supply 1 is grounded; the positive terminal thereof is grounded via the input capacitor 2 and is also connected to one end of the coil 3. The other end of the coil 3 is connected to the anode of the diode 4; the cathode of the diode 4 is grounded via the output capacitor 5. A series circuit composed of the n light-emitting diodes LED1 to LEDn and the output current-setting resistor Rset is connected in parallel to the output capacitor 5.

The step-up chopper regulator IC 100 has, as external connection terminals, a power supply terminal T_{VIN}, a ground terminal T_{GND}, a switch terminal T_{VSW}, a feedback terminal T_{FB} and a control terminal T_{CTRL} The power supply terminal T_{VIN} is connected to the positive terminal of the direct-current power supply 1; the ground terminal T_{GND} is grounded. Thus, the step-up chopper regulator IC 100 obtains power for operation from the direct-current power supply 1. The switch terminal T_{VSW} is connected to the node between the coil 3 and the diode 4; the feedback terminal T_{FB} is connected to the node between the n light-emitting diodes LED1 to LEDn and the output current-setting resistor Rset. On/off signals are inputted to the control terminal T_{CTRL}.

A description will now be given of the internal configuration of and the interconnection in the step-up chopper regulator IC 100. The step-up chopper regulator IC 100 includes an error amplifier 6, a reference-voltage generation circuit 7, a drive circuit 8, a power transistor 9 serving as a switching element and an on/off circuit 10.

One input terminal of the error amplifier 6 is connected to the feedback terminal T_{FB}; the other input terminal of the error amplifier 6 is connected to the output terminal of the reference-voltage generation circuit 7. The output terminal of the error amplifier 6 is connected to the drive circuit 8.

The gate of the power transistor 9 is connected to the drive circuit 8. One of the source and drain of the power transistor 9 is connected to the switch terminal T_{VSW}; the other of the source and drain of the power transistor 9 is grounded.

A description will now be given of the operation of the conventional light-emitting-diode drive circuit configured as described above and shown in FIG. 10. The drive circuit 8 turns on and off the power transistor 9 to generate, across the output capacitor 5, an output voltage Vout obtained by stepping-up an input voltage Vin from the direct-current power supply 1, and thereby drives the light-emitting diodes LED1 to LEDn.

Specifically, when the power transistor 9 is kept on according to a drive signal outputted from the drive circuit 8, a current is passed from the direct-current power supply 1 to the coil 3, and thus energy is stored in the coil 3. When the power transistor 9 is kept off according to the drive signal outputted from the drive circuit 8, the stored energy is released to generate a back electromotive force in the coil 3. The back electromotive force generated in the coil 3 is added to the input voltage Vin from the direct-current power supply 1, and the resultant voltage charges the output capacitor 5 through the diode 4. A series of such operations is repeated to perform a step-up operation, and thus the output voltage Vout is generated across the output capacitor 5. This output voltage Vout allows an output current I out to pass through the light-emitting diodes LED1 to LEDn, with the result that the light-emitting diodes LED1 to LEDn emit light.

A feedback voltage Vfb obtained by multiplying the output current I out by the resistance of the resistor Rset is fed via the feedback terminal T_{FB} to the one of the input terminals of the error amplifier 6 and is compared with a reference voltage Vref fed to the other of the input terminals of the error amplifier 6. Thus, a voltage corresponding to the difference between the feedback voltage Vfb and the reference voltage Vref appears at the output of the error amplifier 6, and this voltage is fed to the drive circuit 8.

The drive circuit 8 receives an output from the error amplifier 6 to turn on and off the power transistor 9 according to a duty ratio corresponding to the output. For example, the drive circuit 8 turns on the power transistor 9 when the output of the error amplifier 6 is high, and turns off the power transistor 9 when the output of the error amplifier 6 is low.

The drive circuit 8 controls the turning on and off of the power transistor 9 as described above, that is, it performs a switching control operation. Specifically, a step-up operation is so performed as to make the feedback voltage Vfb equal to the reference voltage Vref. That is, the output current I out is stabilized at the current obtained by dividing the reference voltage Vref (the feedback voltage Vfb) by the resistance of the resistor Rset.

When the on/off signal inputted to the control terminal T_{CTRL} is in an off state, the on/off circuit 10 turns off the drive circuit 8. Hence, the switching operation of the power transistor 9 is stopped, and thus the output voltage Vout decreases, with the result that the current consumed by the step-up chopper regulator IC 100 is lowered (to about 1n A). In contrast, when the on/off signal is in an on state, the on/off circuit 10 turns on the drive circuit 8. Hence, the power transistor 9 performs the switching operation, and thus the output voltage Vout does not decrease. For example, the on/off signal may be such that when it is low, it indicates an off state, and when it is high, it indicates an on state. In contrast, the on/off signal may also be such that when it is low, it indicates an on state, and when it is high, it indicates an off state.

In the conventional light-emitting-diode drive circuit that drives a plurality of light-emitting diodes connected in series, the series connection of the light-emitting diodes makes it impossible to turn off only one of the light-emitting diodes, with the result that all the light-emitting diodes are either turned on or turned off. Thus, the conventional light-emitting-diode drive circuit controls the amount of light emitted by the light-emitting diodes connected in series through on/off control with a pulse signal like a PWM (pulse width modulation) signal (for example, see JP-A-2005-174725 (paragraph 0038) and JP-A-2006-060009 (paragraph 0030)). In the conventional light-emitting-diode drive circuit described above and shown in FIG. 10, a brightness control signal is fed to the control terminal T_{CTRL} to control the amount of light emitted by the light-emitting diodes. The on/off circuit 10 turns on and off the drive circuit 8 according to the brightness control signal, and thus the average of the current flowing through the light-emitting diodes LED1 to LEDn varies according to the duty ratio of the brightness control signal. Since the brightness of the light-emitting diodes LED1 to LEDn is directly proportional to the average of the current flowing through the light-emitting diodes LED1 to LEDn, the brightness of the light-emitting diodes LED1 to LEDn can be controlled by varying the duty ratio of the brightness control signal.

Disadvantageously, however, with the conventional light-control method described above, a circuit is additionally required that generates pulse signals for light control, and light-control pulse signals varying at relatively short intervals cause high-frequency noise to the light-emitting-diode drive circuit.

Another disadvantage is that when visible light communication or the like in which communication is achieved by the turning on and off of light-emitting diodes at such short intervals that it cannot be perceived by the human eye becomes common, such communication will suffer interference from the light-control method in which light control is achieved with a light-control pulse signal such as a PWM signal by the turning on and off of light-emitting diodes, and thus will become infeasible.

### SUMMARY OF THE INVENTION

An object of the present invention is to provide a light-emitting-diode drive circuit that controls the amount of light emitted by a plurality of light-emitting diodes connected in series without the use of pulse signals.

Still other objects and specific advantages of the invention will become further apparent from the following description.

To achieve the above objects, a light-emitting-diode drive circuit according to the present invention drives n (where n is a natural number equal to or greater than two) light-emitting diodes connected in series, and includes n′ (where n′ is any natural number equal to or greater than one but equal to or less than n−1) lit-LED number control switches. Here, there are n′ ways of turning on only one of the n′ lit-LED number control switches and there are, as corresponding to those n′ ways, n′ ways of lighting different numbers of light-emitting diodes among the n light-emitting diodes connected in series.

With this configuration, when one of the n′ lit-LED number control switches is turned on while the n light-emitting diodes connected in series are lit, the current path is bypassed, and thus the number of light-emitting diodes lit is controlled. Thus, it is possible to control light in n′+2 steps including those in which the n light-emitting diodes are all turned on and off. This makes it possible to control light emitted by a plurality of light-emitting diodes without the use of pulse signals.

In the light-emitting-diode drive circuit configured as described above, the n′ lit-LED number control switches are preferably transistors. Thus, it is possible to electrically control the turning on and off of the lit-LED number control switches. Moreover, n′ external control signals may be assigned and inputted to control terminals of the n′ transistors, respectively. A control section may be provided that receives a voltage commensurate with a current flowing through the light-emitting diodes lit and that controls, according to the received voltage, how many of the n light-emitting diodes connected in series are lit. A decoder circuit may be provided that decodes m (where m is a natural number equal to or greater than one but less than the n′, but in this case, the n′ is limited to any natural number equal to or greater than two) external control signals to generate n′ control signals, and the n′ control signals generated by the decoder circuit may be assigned and inputted to control terminals of the n′ transistors, respectively. An illumination sensor and a control section controlling, according to a signal outputted from the illumination sensor, how many of the n light-emitting diodes connected in series are lit may be provided.

In the light-emitting-diode drive circuit configured as described above, the n light-emitting diodes connected in series may be composed of two or more kinds of light-emitting diodes that emit light having different colors. Here, how many of the n light-emitting diodes connected in series are lit may be controlled with the n′ lit-LED number control switches such that emission color of the n light-emitting diodes connected in series as a whole is varied. In this way, it is possible not only to control light but also to control color of light emitted.

In the light-emitting-diode drive circuit configured as described above, when one or more of the n light-emitting diodes connected in series become defective and thus open-circuited, the light-emitting-diode drive circuit may attempt to escape from a situation where the n light-emitting diodes connected in series are all off by turning on one of the n′ lit-LED number control switches. Thus, it is possible to bypass, even when one or more of the n light-emitting diodes connected in series become defective and thus open-circuited, the current path including the defective light-emitting diode to light all or some of the non-defective light-emitting diodes. Specifically, for example, when the light-emitting-diode drive circuit receives a signal corresponding to the turning on and off of a light-responsive element arranged near the n light-emitting diodes connected in series, and the received signal indicates that the light-responsive element is off, it may attempt to escape from a situation where the n light-emitting diodes connected in series are all off.

In the light-emitting-diode drive circuit configured as described above, when the n light-emitting diodes connected in series are tuned on or off, the n light-emitting diodes connected in series may be turned on or off with the n′ lit-LED number control switches on a one-by-one basis or in units of two or three. Thus, it is possible to reduce a surge voltage that adversely affects the light-emitting-diode drive circuit and peripheral elements connected thereto as compared with the case where the light-emitting diodes are all turned on or off at the same time.

With the light-emitting-diode drive circuit according to the present invention, when one of the n′ (where n′ is any natural number equal to or greater than two but equal to or less than n) lit-LED-number control switches is turned on, how many of the n (where n is any natural number equal to or greater than two) light-emitting diodes connected in series are lit is controlled. Thus, it is possible to control light in n′+2 steps including those in which the n light-emitting diodes are all turned on and off. This makes it possible to control light emitted by the n light-emitting diodes without the use of pulse signals.

### BRIEF DESCRIPTION OF THE DRAWINGS

FIG. 1 is a diagram showing the configuration of a light-emitting-diode drive circuits according to a first, an eighth or a tenth embodiment of the present invention.

FIG. 2 is a diagram showing the configuration of a light-emitting-diode drive circuit according to a second embodiment of the invention.

FIG. 3 is a diagram showing the configuration of a light-emitting-diode drive circuit according to a third embodiment of the invention.

FIG. 4 is a diagram showing the configuration of a light-emitting-diode drive circuit according to a fourth embodiment of the invention.

FIG. 5 is a diagram showing the configuration of a light-emitting-diode drive circuit according to a fifth embodiment of the invention.

FIG. 6 is a diagram showing the configuration of a light-emitting-diode drive circuit according to a sixth embodiment of the invention.

FIG. 7 is a diagram showing the configuration of a light-emitting-diode drive circuit according to a seventh embodiment of the invention.

FIG. 8 is a diagram showing the configuration of a light-emitting-diode drive circuit according to a ninth embodiment of the invention.

FIGS. 9A and 9B are diagrams schematically showing modified examples of the invention.

FIG. 10 is a diagram showing an example of the configuration of a conventional light-emitting-diode drive circuit.

### DETAILED DESCRIPTION OF PREFERRED EMBODIMENTS

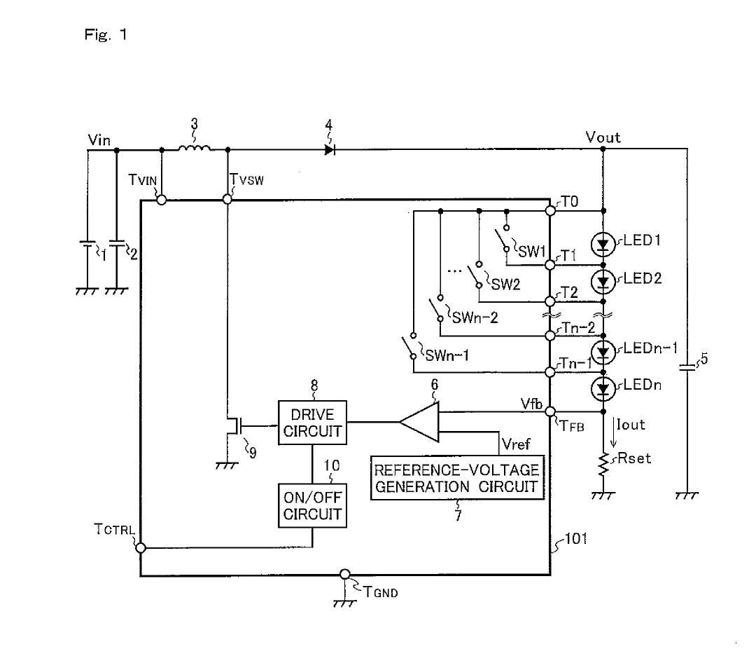

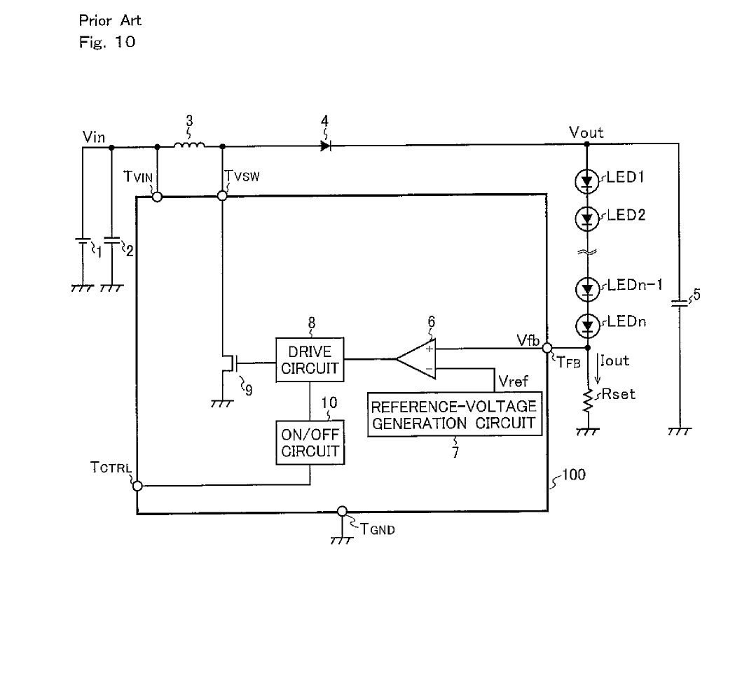

Hereinafter, embodiments of the present invention will be described with reference to the accompanying drawings. A description will first be given of a first embodiment of the invention. The configuration of a light-emitting-diode drive circuit according to the first embodiment of the invention is shown in FIG. 1. In FIG. 1, such parts as are found also in FIG. 10 are identified with common reference numerals, and their detailed description will not be repeated.

The light-emitting-diode drive circuit shown in FIG. 1 according to the first embodiment of the invention differs from the conventional light-emitting-diode drive circuit shown in FIG. 10 in that the step-up chopper regulator IC 100 is replaced with a step-up chopper regulator IC 101. The step-up chopper regulator IC 101 differs from the step-up chopper regulator IC 100 in that it is additionally provided with: lit-LED-number control switches SW1 to SWn−1; a terminal T0 to which one ends of the lit-LED-number control switches are all connected; and terminals T1 to Tn−1 to which the other ends of the lit-LED-number control switches are respectively connected. The terminal T0 is connected to the anode of a light-emitting diode LED1; a terminal Tk is connected to the node between the cathode of a light-emitting diode LEDk and the anode of a light-emitting diode LEDk+1 (k is any natural number equal to or greater than one but equal to or less than n−1).

With this configuration, when one of the lit-LED-number control switches SW1 to SWn−1 is turned on while the light-emitting diodes are lit, the lit-LED-number control switch turned on bypasses the current path. Thus, it is possible to light the number of light-emitting diodes corresponding to the lit-LED-number control switch turned on. Specifically, when a lit-LED-number control switch SWk is turned on, n−k light-emitting diodes (k is any natural number equal to or greater than one but equal to or less than n−1) can be lit. Thus, without the use of pulse signals such as PWM signals, it is possible to control light in n+1 steps including those in which the light-emitting diodes are all turned on and off.

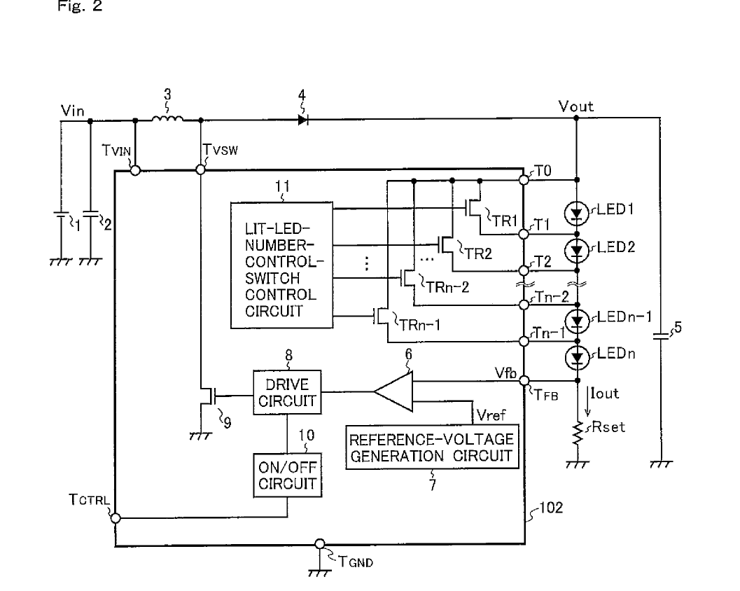

A second embodiment of the present invention will now be described. The configuration of a light-emitting-diode drive circuit according to the second embodiment of the invention is shown in FIG. 2. In FIG. 2, such parts as are found also in FIG. 1 are identified with common reference numerals, and their detailed description will not be repeated.

The light-emitting-diode drive circuit shown in FIG. 2 according to the second embodiment of the invention differs from that shown in FIG. 1 according to the first embodiment of the invention in that the step-up chopper regulator IC 101 is replaced with a step-up chopper regulator IC 102. The step-up chopper regulator IC 102 differs from the step-up chopper regulator IC 101 in that transistors TR1 to TRn−1 are used to serve as the lit-LED number control switches SW1 to SWn−1, and a lit-LED-number-control-switch control circuit 11 is additionally provided that turns on one of the transistors TR1 to TRn−1 to control how many of the light-emitting diodes LED1 to LEDn are lit. To light all the light-emitting diodes LED1 to LEDn without controlling the number of LEDs lit) the lit-LED-number-control-switch control circuit 11 turns off all the transistors TR1 to TRn−1.

With this configuration, it is possible to electrically control the turning on and off of the lit-LED-number control switches (here, the transistors TR1 to TRn−1).

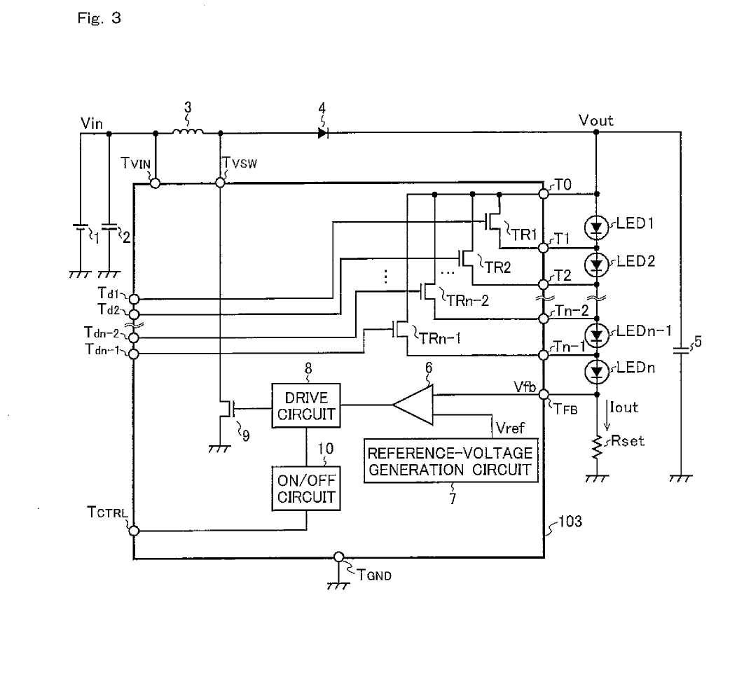

A third embodiment of the present invention will now be described. The configuration of a light-emitting-diode drive circuit according to the third embodiment of the invention is shown in FIG. 3. In FIG. 3, such parts as are found also in FIG. 2 are identified with common reference numerals, and their detailed description will not be repeated.

The light-emitting-diode drive circuit shown in FIG. 3 according to the third embodiment of the invention differs from that shown in FIG. 2 according to the second embodiment of the invention in that the step-up chopper regulator IC 102 is replaced with a step-up chopper regulator IC 103. The step-up chopper regulator IC 103 differs from the step-up chopper regulator IC 102 in that instead of the lit-LED-number-control-switch control circuit 11, terminals Td1 to Tdn−1 are provided through which external input logic signals are fed to the control terminals of the transistors TR1 to TRn−1.

By inputting, from a control IC such as a microcomputer, to one of the terminals T d1 to Tdn−1 the external input logic signal that turns on one of the transistors TR1 to TRn−1 and to the others of the terminals Td1 to Tdn−1 the external input logic signals that turn off the others of the transistors TR1 to TRn−1, it is possible to electrically control, from the control IC such as a microcomputer, the turning on and off of the lit-LED number control switches (here, the transistors TR1 to TRn−1). To light all the light-emitting diodes LED1 to LEDn without controlling the number of LEDs lit, the external input logic signals that turn off all the transistors TR1 to TRn−1 are inputted from the control IC such as a microcomputer to the terminals Td1 to Tdn−1.

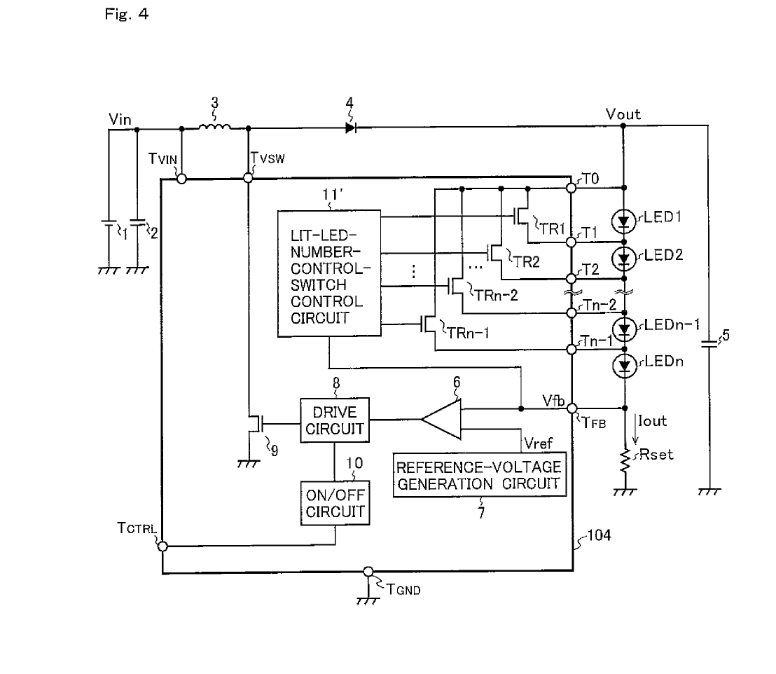

A fourth embodiment of the present invention will now be described. The configuration of a light-emitting-diode drive circuit according to the fourth embodiment of the invention is shown in FIG. 4. In FIG. 4, such parts as are found also in FIG. 2 are identified with common reference numerals, and their detailed description will not be repeated.

The light-emitting-diode drive circuit shown in FIG. 4 according to the fourth embodiment of the invention differs from that shown in FIG. 2 according to the second embodiment of the invention in that the step-up chopper regulator IC 102 is replaced with a step-up chopper regulator IC 104. The step-up chopper regulator IC 104 differs from the step-up chopper regulator IC 102 in that the lit-LED -number-control-switch control circuit 11 is replaced with a lit-LED-number-control-switch control circuit 11′.

When the lit-LED-number-control-switch control circuit 11′ receives a feedback voltage Vfb and finds it to be lower than a predetermined threshold Vth (here, the threshold Vth< the reference voltage Vref), the lit-LED-number-control-switch control circuit 11′ lights an appropriate number of light-emitting diodes so as to obtain an appropriate feedback terminal voltage Vfb by controlling the turning on and off of the lit-LED-number control switches (here, the transistors TR1 to TRn−1). For example, when the lit-LED-number-control-switch control circuit 11′ receives the feedback voltage Vfb and finds it to be lower than the predetermined threshold Vth (here, the threshold Vth< the reference voltage Vref), it first turns on the transistor TR1 alone to light n−1 light-emitting diodes. If the feedback voltage Vfb is still lower than the predetermined threshold Vth, it turns on the transistor TR2 alone to light n−2 light-emitting diodes. Such a sequence of operations is repeated until the feedback voltage Vfb becomes equal to or higher than the threshold Vth. In this way, the light-emitting-diode drive circuit can quickly escape from a situation where since a light-emitting diode that requires an unexpectedly high forward voltage Vf due to variations in properties of the light-emitting diodes LED1 to LEDn is connected in series with an output terminal, a voltage beyond the highest voltage that the chopper regulator can supply is required, and thus the voltage at the feedback terminal fails to reach a predetermined threshold voltage.

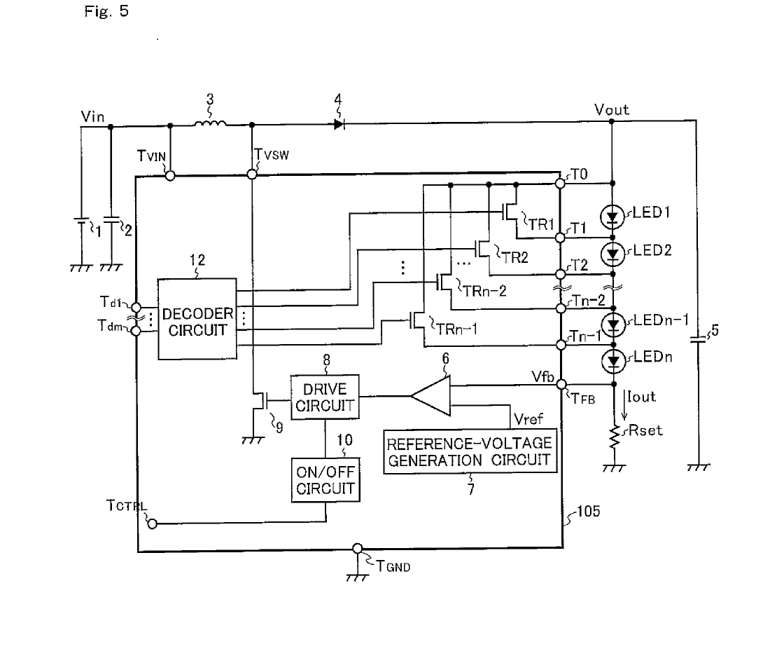

A fifth embodiment of the present invention will now be described. The configuration of a light-emitting-diode drive circuit according to the fifth embodiment of the invention is shown in FIG. 5. In FIG. 5, such parts as are found also in FIG. 3 are identified with common reference numerals, and their detailed description will not be repeated.

The light-emitting-diode drive circuit shown in FIG. 5 according to the fifth embodiment of the invention differs from that shown in FIG. 3 according to the third embodiment of the invention in that the step-up chopper regulator IC 103 is replaced with a step-up chopper regulator IC 105. The step-up chopper regulator IC 105 differs from the step-up chopper regulator IC 103 in that instead of the terminals Td1 to Tdn−1 through which n−1 external input logic signals are inputted, terminals Td1 to Tdm are provided through which m (here, m<n−1) external input logic signals are inputted, and a decoder circuit 12 is additionally provided that generates n−1 control signals fed to the control terminals of the transistors TR1 to TRn−1 by decoding the m external input logic signals inputted through the terminals Td1 to Tdm.

With this configuration, it is possible to control the turning on and off of the lit-LED-number control switches (here, the transistors TR1 to TRn−1) by use of the external input logic signals fewer in number than the lit-LED number control switches that needs to be controlled.

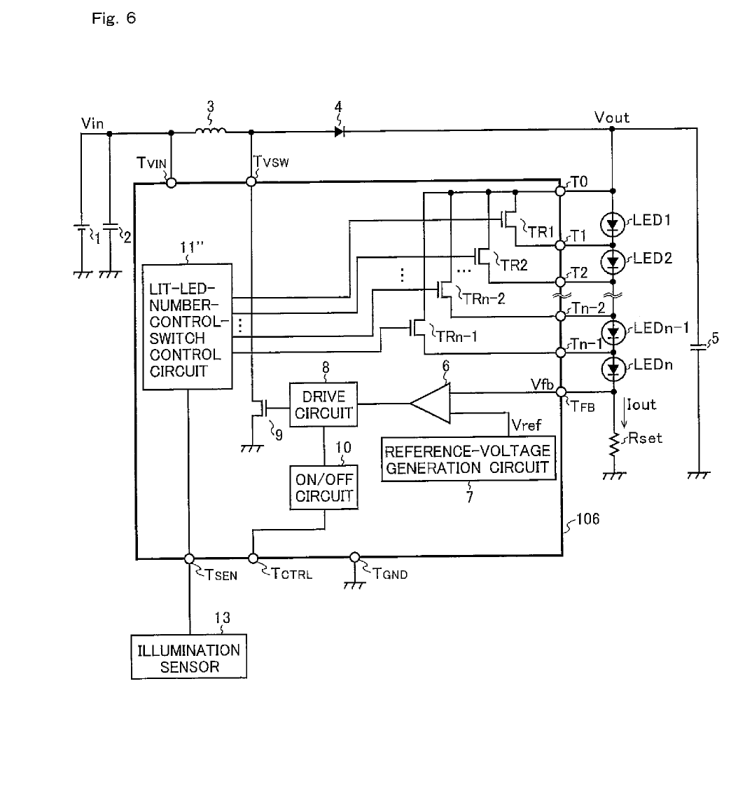

A sixth embodiment of the present invention will now be described. The configuration of a light-emitting-diode drive circuit according to the sixth embodiment of the invention is shown in FIG. 6. In FIG. 6, such parts as are found also in FIG. 3 are identified with common reference numerals, and their detailed description will not be repeated.

The light-emitting-diode drive circuit shown in FIG. 6 according to the sixth embodiment of the invention differs from that shown in FIG. 2 according to the second embodiment of the invention in that the step-up chopper regulator IC 102 is replaced with a step-up chopper regulator IC 106. The step-up chopper regulator IC 106 differs from the step-up chopper regulator IC 102 in that the lit-LED-number-control-switch control circuit 11 is replaced with a lit-LED-number-control-switch control circuit 11″, and a terminal TSEN is additionally provided.

The lit-LED-number-control-switch control circuit 11″ controls the turning on and off of the lit-LED-number control switches (here, the transistors TR1 to TRn−1) according to the signal received through the terminal TSEN. In this embodiment, since the signal received through the terminal TSEN is outputted from an illumination sensor 13, the lit-LED-number-control-switch control circuit 11″ controls the turning on and off of the lit-LED number control switches (here, the transistors TR1 to TRn−1) according to the signal outputted from the illumination sensor 13. For example, as the intensity of illumination detected by the illumination sensor 13 decreases, the lit-LED-number-control-switch control circuit 11″ increases the number of light-emitting diodes lit among the light-emitting diodes LED1 to LEDn. Thus, with the light-emitting-diode drive circuit shown in FIG. 6 according to the sixth embodiment of the invention, it is possible to control light according to the intensity of ambient light.

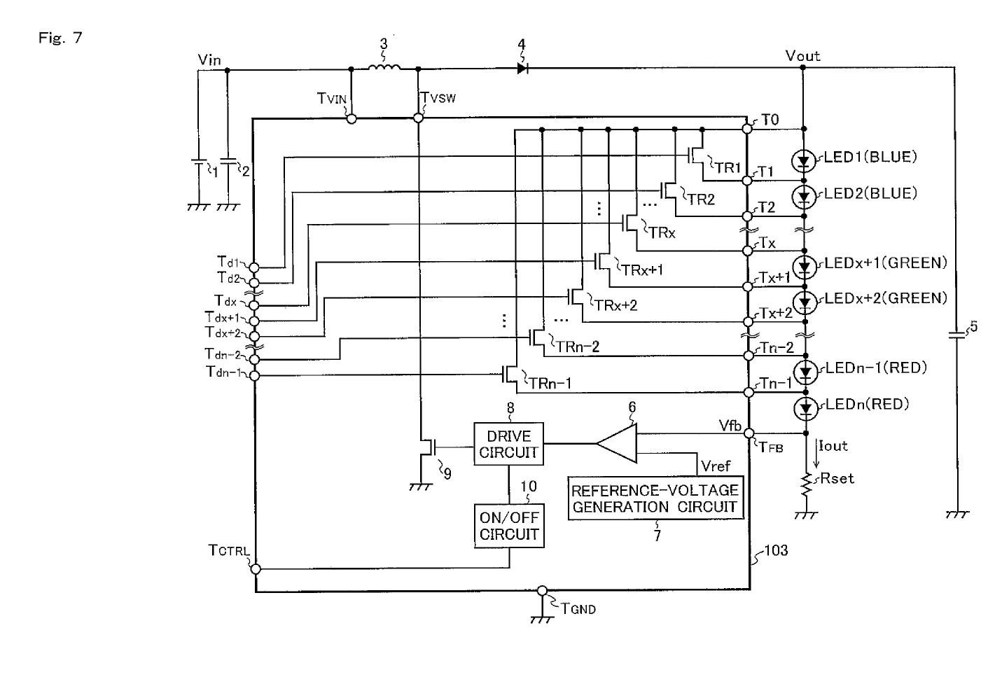

A seventh embodiment of the present invention will now be described. The configuration of a light-emitting-diode drive circuit according to the seventh embodiment of the invention is shown in FIG. 7. In FIG. 7, such parts as are found also in FIG. 3 are identified with common reference numerals, and their detailed description will not be repeated.

In this embodiment, the light-emitting diodes LED1 to LEDn are composed of a plurality of blue light-emitting diodes, a plurality of green light-emitting diodes and a plurality of red light-emitting diodes connected in series in this order. Thus, it is possible to vary the emission color of the light-emitting diodes as a whole by controlling the turning on and off of the lit-LED-number control switches (here, the transistors TR1 to TRn−1). For example, when the plurality of red light-emitting diodes are only lit, red light is emitted; when the plurality of red light-emitting diodes and the plurality of green light-emitting diodes are only lit, yellow light is emitted; and when all the light-emitting diodes LED1 to LEDn are lit, white light is emitted.

An eighth embodiment of the present invention will now be described. The configuration of a light-emitting-diode drive circuit according to the eighth embodiment of the invention is the same as that (see FIG. 1) of the light-emitting-diode drive circuit according to the first embodiment of the invention.

According to the method in which a chopper regulator or the like is used as a drive circuit and light-emitting diodes are connected in series so that the same amount of forward current is passed when the light-emitting diodes are driven, when any one or more of the n light-emitting diodes connected in series with the output terminal of the drive circuit become defective and thus open-circuited, all the light-emitting diodes are usually turned off.

In contrast, in the light-emitting-diode drive circuit according to the eighth embodiment of the invention, even when any one or more of the light-emitting diodes LED1 to LEDn−1 become defective and thus open-circuited, one of the lit-LED-number control switches SW1 to SWn−1 is turned on and thus the current path including the defective light-emitting diode is bypassed. In this way, it is possible to light all or some of the non-defective light-emitting diodes.

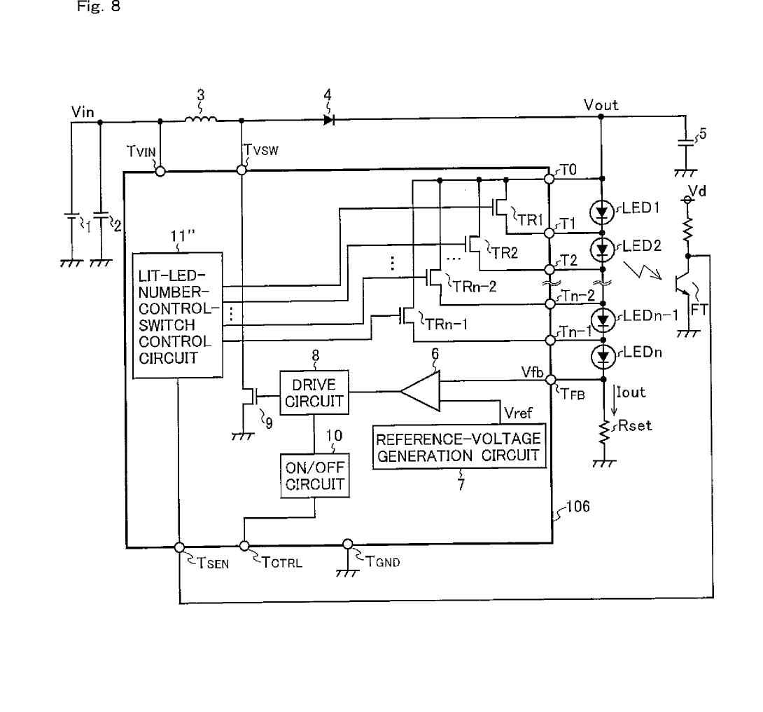

A ninth embodiment of the present invention will now be described. The configuration of a light-emitting-diode drive circuit according to the ninth embodiment of the invention is shown in FIG. 8. In FIG. 8, such parts as are found also in FIG. 6 are identified with common reference numerals, and their detailed description will not be repeated.

The lit-LED-number-control-switch control circuit 11″ controls the turning on and off of the lit-LED number control switches (here, the transistors TR1 to TRn−1) according to the signal received through the terminal TSFN. In this embodiment, since the terminal TSEN is connected to the collector of a photo transistor FT arranged near the light-emitting diodes LED1 to LEDn, the lit-LED-number-control-switch control circuit 11″ controls the turning on and off of the lit-LED number control switches (here, the transistors TR1 to TRn−1) according to the turning on and off of the photo transistor FT arranged near the light-emitting diodes LED1 to LEDn.

For example, when any one or more of the light-emitting diodes LED1 to LEDn−1 become defective and thus open-circuited, then the light-emitting diodes LED1 to LEDn−1 are all turned off, then the phototransistor FT is tuned off and then a high-level signal is inputted to the terminal TSEN, the lit-LED-count-control-switch control circuit 11″ first turns on the transistor TR1 alone. If a high-level signal is still inputted to the terminal TSEN, the transistor TR2 is only turned on. The lit-LED-number-control-switch control circuit 11′ repeats a series of such operations until a high-level signal is no longer inputted to the terminal TSEN. In this way, it is possible to achieve the following operation: even when any one or more of the light-emitting diodes LED1 to LEDn−1 become defective and thus open-circuited, and hence all the light-emitting diodes LED1 to LEDn−1 are turned off, all or some of the non-defective light-emitting diodes are lit automatically.

Finally, a tenth embodiment of the present invention will be described. The configuration of a light-emitting-diode drive circuit according to the tenth embodiment of the invention is the same as that (see FIG. 1) of the light-emitting-diode drive circuit according to the first embodiment of the invention.

The light-emitting-diode drive circuit according to the tenth embodiment of the invention uses, when the light-emitting diodes are turned on or off, the lit-LED number control switches SW1 to SWn−1 to gradually turn on or off the light-emitting diodes LED1 to LEDn one by one or in units of two or three. For example, when the tight-emitting diodes LED1 to LEDn are gradually turned on one by one, the transistor TRn−1 alone is first turned on to light only one light-emitting diode, namely, the light-emitting diode LED n, and then the transistor TRn−2 is only turned on to light only two light-emitting diodes, namely, the light-emitting diodes LED n and LED n−1. A series of such operations are repeated until the transistor TR1 is only turned on. Finally, the transistors TR1 to TRn−1 are all turned off to light all the light-emitting diodes LED1 to LEDn. Thus, it is possible to reduce a surge voltage that adversely affects the light-emitting-diode drive circuit according to the tenth embodiment of the invention and peripheral elements connected thereto.

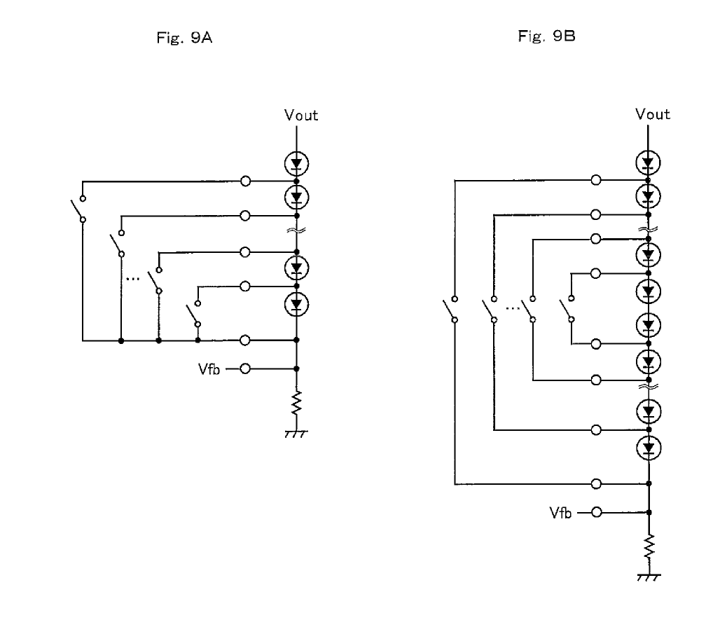

Although in the embodiments described above, one ends of the lit-LED number control switches are all connected to the anode of the light-emitting diode LED 1, the present invention is not limited to this configuration. For example, as schematically shown in FIG. 9A, one ends of the lit-LED number control switches may all be connected to the cathode of the light-emitting diode LED n, and as schematically shown in FIG. 9B, each end of the lit-LED number control switches does not need to be connected together.

What is claimed is:

1. A light-emitting-diode drive circuit for driving n (where n is a natural number equal to or greater than two) light-emitting diodes connected in series, the light-emitting-diode drive circuit comprising:
n′ (where n′ is any natural number equal to or greater than one but equal to or less than n−1) lit-LED number control switches,
wherein there are n′ ways of turning on only one of the n′ lit-LED number control switches and there are, as corresponding to those n′ ways, n′ ways of lighting different numbers of light-emitting diodes among the n light-emitting diodes connected in series.

2. The light-emitting-diode drive circuit of claim 1, wherein the n′ lit-LED number control switches are transistors.

3. The light-emitting-diode drive circuit of claim 2, wherein n′ external control signals are assigned and inputted to control terminals of the n′ transistors, respectively.

4. The light-emitting-diode drive circuit of claim 2, further comprising:
a control section that receives a voltage commensurate with a current flowing through the light-emitting diodes lit and that controls, according to the received voltage, how many of the n light-emitting diodes connected in series are lit.

5. The light-emitting-diode drive circuit of claim 2, further comprising:
a decoder circuit decoding in (where m is a natural number equal to or greater than one but less than the n′, but in this case, the n′ is limited to any natural number equal to or greater than two) external control signals to generate n′ control signals, wherein the n′ control signals generated by the decoder circuit are assigned and inputted to control terminals of the n′ transistors, respectively.

6. The light-emitting-diode drive circuit of claim 2, further comprising:
an illumination sensor; and
a control section controlling, according to a signal outputted from the illumination sensor, how many of the n light-emitting diodes connected in series are lit.

7. The light-emitting-diode drive circuit of claim 1,
wherein the n light-emitting diodes connected in series are composed of two or more kinds of light-emitting diodes that emit light having different colors, and how many of the n light-emitting diodes connected in series are lit is controlled by the n′ lit-LED number control switches such that emission color of the n light-emitting diodes connected in series as a whole is varied.

8. The light-emitting-diode drive circuit of claim 1,
wherein when one or more of the n light-emitting diodes connected in series become defective and open-circuited, the light-emitting-diode drive circuit attempts to escape from a situation where the n light-emitting diodes connected in series are all off by turning on only one of the n′ lit-LED number control switches.

9. The light-emitting-diode drive circuit of claim 8,
wherein when a signal corresponding to turning on and off of a light-responsive element arranged near the n light-emitting diodes connected in series is received, and the received signal indicates that the light-responsive element is off, the light-emitting-diode drive circuit attempts to escape from a situation where the n light-emitting diodes connected in series are all off.

10. The light-emitting-diode drive circuit of claim 1,
wherein when the n light-emitting diodes connected in series are tuned on or off, the n light-emitting diodes connected in series are turned on or off by the n′ lit-LED number control switches on a one-by-one basis or in units of two or three.
